(19) United States
(12) Patent Application Publication
(10) Pub. No.: US 2026/0321796 A1
(43) Pub. Date: Oct. 15, 2026

(54) Battery Module

(71) Applicant: Mercedes-Benz Group AG, Stuttgart (DE)

(72) Inventors: Marius Yves KUHN, Winterlingen (DE); Klaus HUBER, Esslingen am Neckar (DE)

(21) Appl. No.: 18/998,721

(22) PCT Filed: Jun. 29, 2023
(86) PCT No.: PCT/EP2023/067911

§ 371 Date: Jan. 27, 2025

(30) Foreign Application Priority Data
Jul. 28, 2022 (DE) 10 2022 002 745.3

(51) Int. Cl. H01M 10/6571; H01M 10/0525; H01M 10/615; H01M 50/213

(52) U.S. Cl. CPC H01M 10/6571; H01M 10/0525; H01M 10/615; H01M 50/213

(57) ABSTRACT

A battery module includes a plurality of individual battery cells in a housing and an integrated module heater where the integrated module heater is a foam material which is disposed in an electric circuit together with a switching element. The foam material is electrically conductive and fixes the plurality of individual battery cells in the housing and when the switching element is switched on an electric current flows through the foam material and heats the foam material.

### BACKGROUND AND SUMMARY OF THE INVENTION

The invention relates to a battery module having a plurality of individual battery cells in a housing of the type defined in more detail herein.

Battery modules, in particular battery modules which are constructed based on lithium-ion battery cells, have to be operated in a particular temperature range as far as possible, in order to achieve the best function and the longest service life. Therefore, it is necessary to heat the individual battery cells of the battery module in the case of cold ambient temperatures, and it is necessary to cool them in the case of high temperatures. This serves to prevent so-called “lithium plating” in the individual battery cells with liquid electrolyte. Furthermore, very high temperature gradients in the active material of the individual battery cells negatively affect the service life of the individual battery cells.

It is known from the general prior art that a cooling medium, which is typically in heat-conducting contact with the individual battery cells via a heat exchanger, can be used on the one hand for heating the individual battery cells and on the other hand for cooling them. Therefore, for example, the cooling medium is accordingly warmed up in the case of cold ambient temperatures via an electrical resistance heating element, in order to control the temperature of the individual battery cells in the desired manner indirectly via the cooling medium. However, it is possible that the high temperature gradients that occur when the cooling medium is used on the one hand for cooling and on the other hand for warming up the individual battery cells may damage the coolant. For example, gelling can occur, so that the coolant then has to be completely replaced in order to ensure that the functionality continues.

Furthermore, due to the use of various components and the required heat transfers from the heating element to the coolant on the one hand and from the coolant to the individual battery cells on the other hand, heating the individual battery cells via the cooling medium results in a comparatively slow and inefficient process which requires far more energy to control the temperature of the individual battery cells than is absolutely necessary.

Furthermore, flat heating foils which can be integrated into the battery module are known. These are however comparatively cost-intensive and require additional installation space. Nevertheless, they are frequently used in the field of solid-state batteries, for example, for which reference can be made to DE 10 2016 214 337 A1 .

DE 10 2017 206 080 A1 describes a battery module in which an elastically and/or plastically deformable compensating element is arranged between each of the individual battery cells. An electric heating element in the form of a heating foil can be positioned inside this compensating element. This heating element is then surrounded on both sides by the elastic material and can heat the individual battery cells through this elastically and/or plastically deformable material of the compensating element if required.

A similar construction having a porous and flexible compensating element, which can also be used for controlling the temperature of the cells, is described in DE 10 2009 052 508 A1. Although it is explained here that the material can be both thermally and electrically conductive, no mention is made of electrical heating; instead, only the heat conductivity of the compensating element is mentioned, which can then transfer heat from a connected heating system or cooling device to the cells.

Finally, DE 10 2016 214 640 A1 also describes a battery module in which an electrically isolating potting compound is used in order to fix the individual battery cells. This electrically isolating potting compound can be provided with silver particles or the like for improving the heat conductivity.

The object of the present invention is to create an improved battery module having a plurality of individual battery cells and an integrated module heater, which battery module avoids the aforementioned disadvantages and enables simple, efficient and cost-effective heating of the battery module, when necessary. Furthermore, it is the object to specify a method for heating a battery having a plurality of battery modules of such type.

The battery module according to the invention is provided with an integrated module heater which is formed by an electrically conductive resistive material. According to the invention, the material of the module heater is designed as a foamed material and fixes the individual battery cells in the housing. On the one hand, the material serves to position and fix the individual battery cells in the housing and therefore surrounds the individual battery cells over a large part of their respective exterior surface. The material is designed as an electrically conductive thermal foam, which in particular is also made flame retardant by adding a flame retardant to it. This electrically conductive thermal foam then forms a part of the electric circuit together with a switching element, so that when the switching element is switched on, electric current flows through the thermal foam and this is accordingly heated due to the electrical resistance of the current in the thermal foam. The thermal foam can then distribute the warm energy directly to the individual battery cells in direct contact with it, so that extremely efficient heating is possible. Since the thermal foam simultaneously takes on the fixing of the individual battery cells in the housing, additional installation space is not required for it, since it would be available for fixing the individual battery cells in any case and now only takes on the additional task of the module heater.

According to an extraordinarily favorable development of the battery module according to the invention, it can thus be provided that the thermal foam is constructed as a polyurethane foam with electrically conductive additives, for example based on coal or aluminium, in particular graphite and/or aluminium oxides. Other electrically conductive additives would however also be conceivable. Due to the electrically conductive additives and preferably an additional flame retardant, such a PU foam is thus an ideal thermal foam on the one hand for fixing the battery cells in the housing and on the other hand for forming a module heater. Furthermore, a high level of safety in the case of thermal runaway of the battery module can be achieved by the flame retardant.

According to a very advantageous further development of the battery module according to the invention, the electric circuit itself can connect the poles of the battery module via the switching element and the module heater. The energy for the module heater is therefore supplied in the module itself, by a part of the energy content of the battery module being used for the module heater. Thus, very efficient heating of the respective battery module is possible.

Every individual module can thus be heated in a targeted manner by forming the electric circuit between the poles of the battery module, even in the case that a battery is constructed of several battery modules, as is common practice, for example, with traction batteries in electrically driven vehicles. Heating by module then allows for very efficient heating of the entire battery, since only those modules actually have to be supplied with that amount of heating energy which is currently required for exactly this module.

If the battery module or the battery comprising the battery module is connected to a charging device, then the power of the charging device is also located at least indirectly at the poles of the respective battery module. In this situation, if the battery module is heated, the energy can be supplied directly via the charging device in the case of the described construction of the electric circuit, without initially having to be stored in the battery module, thereby correspondingly increasing the energy efficiency.

According to a very advantageous embodiment of the battery module according to the invention, the switching element can be formed as a bipolar transistor with an insulated gate electrode (IGBT). The current flow through the switching element and thus through the module heater of the battery module can then be easily and efficiently controlled or regulated via a corresponding control voltage at the gate electrode, for example by means of pulse-width modulated control.

A very favorable embodiment of the battery module according to the invention can further provide that the electrical contacting of the material of the module heater is realized via a first electrode at a first end of the battery module and via a second electrode at a second opposite end of the battery module. These electrodes can be integrated into the expanded material of the module heater or also arranged adjacent to this. They can then be connected directly to the poles of the battery module in order to form the electric circuit. The switching element can then be integrated into one of these connections, for example between the first electrode and the positive pole of the battery module.

In this case, it is particularly favorable when, and it is provided according to an advantageous further development of this idea that, the electrodes each have projections or hooks protruding in the direction of the other electrode. On the one hand, such projections or hooks can facilitate the positioning of the electrodes with respect to the individual battery cells and, on the other hand, they can improve the electrical contacting by increasing the contact surface between the foamed material of the module heater and the electrode.

A further very favorable embodiment can provide that the individual battery cells are arranged in heat-conducting connection with a heat exchanger. The module heater can take over the temperature control of the individual battery cells insofar as it needs to heat the individual battery cells. Furthermore, a heat exchanger known per se can now be provided which, for example, is heat-conductingly connected to the elements of the individual battery cells protruding beyond the foamed fixing. Such a heat exchanger can be a cooling plate, for example, through which a fluid can flow and which is brought into contact with the individual battery cells in the battery module, for example from above and/or below. One or both of the cooling plates can then be used for cooling the individual battery cells in the conventional manner, without having to carry out the heating of the individual battery cells via the coolant, since this heating can take place directly via the module heater. As a result, the coolant is accordingly saved from use and a long service life is achieved with good quality coolant and therefore good cooling efficiency.

In principle, the battery module can be constructed from any individual battery cells. In particular, it is preferable that this is to be realized with lithium-ion cells, wherein the cells are designed as individual battery cells with liquid electrolyte, as is provided according to a very advantageous embodiment of the battery module according to the invention.

The method according to the invention for heating a battery with battery modules according to one of the preceding claims provides according to the invention that the switching units of the battery modules are controlled in a pulse-width-modulated manner according to the required heat energy. This can take place in the preferred embodiment as a bipolar transistor with an insulated gate electrode (IGBT) preferably by controlling the gate voltage accordingly. The pulse-width-modulated control simply and efficiently enables a comparatively good regulation of the introduced heat energy. The amount of heat required by each individual battery module can be supplied by the module heater, integrated into the respective module, corresponding to a temperature as a control variable that is measured in the respective module. Such a temperature control allows the heat energy required by each individual battery module to be effortlessly controlled ideally within a larger battery with several battery modules in a very simple manner. Since the control is part of the modules themselves, virtually no additional effort is involved here, in particular when each of the modules comprises an integrated temperature sensor and an electronic control system that supplies the gate voltage for the IGBT in a pulse-width-modulated manner.

According to a very advantageous further development of the method according to the invention, it can be provided that the module heater is only activated when a state of charge of the corresponding battery module is within specified limit values. Such activation can take place for example in such a way that the state of charge does not fall below a specified limit value, in order to ensure that a vehicle which uses the battery can always reach the required remaining range with the amount of energy stored in the respective battery module. Furthermore, such an activation of the fundamental possibility of module heating according to the state of charge can prevent the module from being discharged to a great extent, which has a positive effect on the service life.

Further advantageous embodiments of the battery module according to the invention and of the method according to the invention result from the exemplary embodiment which is described in more detail below with reference to the figures.

### BRIEF DESCRIPTION OF THE DRAWINGS

FIG. 1 shows a schematic plan view of a battery module in an embodiment according to the invention; and

FIG. 2 shows a side view of the battery module according to FIG. 1.

### DETAILED DESCRIPTION OF THE DRAWINGS

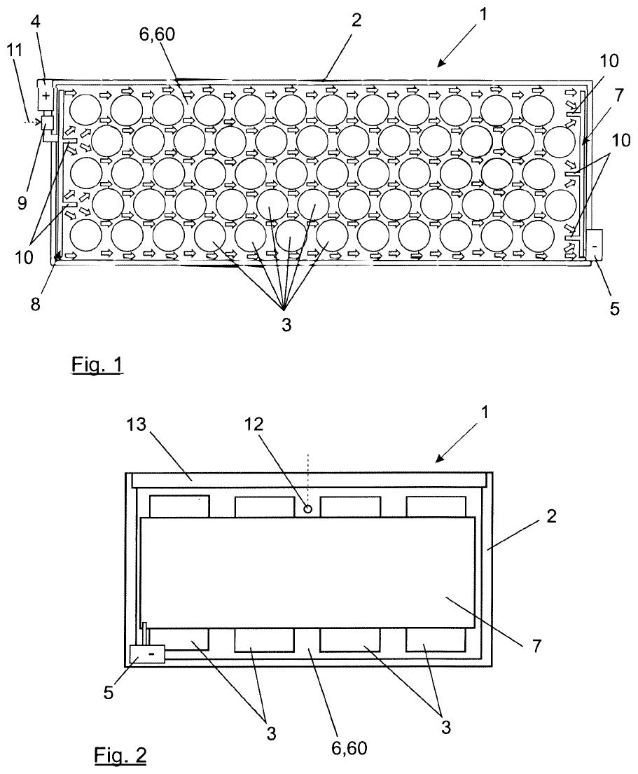

In the representation of FIG. 1, a plan view of a battery module, marked in its entirety with 1, can be seen. It consists of a housing, marked with 2, and a plurality of individual battery cells 3, which here are designed by way of example as round cells. These individual battery cells 3 are arranged vertically in the housing 2. Only a few of them are provided with a reference numeral. The battery poles 4, 5 of the battery module 1, marked positive and negative respectively, can be seen in the top left and bottom right, the individual battery cells 3 of which are connected in a conventional way, for example electrically in series. For fixing the individual battery cells 3 in the housing 2, the latter is foamed with a material marked 6. The individual battery cells 3 can therefore be positioned in the housing 2 that is open at the top for example, and are then fixed by the foam material 6, a thermal foam, in the housing. This thermal foam 6 ensures the mechanical integrity of the cell composite by reliably filling the intermediate spaces between the individual battery cells 3. This increases the robustness and the compression, tensile and shear strength of the cell composite of the battery module 2. The thermal foam 6 used can be a polyurethane foam for example, which can be flame-resistant by using flame retardant. Additionally, electrically conductive particles are added to the thermal foam 6, which for example can contain a combination of carbon or graphite and/or aluminium oxide, for example, AI2O3. These can be arranged as powders or fibres in the thermal foam 6. The thermal foam 6 is therefore electrically conductive and has improved characteristics with regard to heat conductivity.

The electrical conductivity of the thermal foam 6 can be used by integrating an electrode 7, 8 into the housing 2, on the left and right end respectively in the exemplary embodiment shown here, which electrode is correspondingly closely connected to the thermal foam 6. The electrode 8 represented on the left is connected to the positive pole 4 via a switching element 9, which is preferably designed as an IGBT, and the electrode 7 represented on the right is connected electrically directly to the negative pole 5 of the battery module 1. The two electrodes 7, 8 are connected to the electrically conductive resistive thermal foam 6. The electrodes 7, 8 can have projections 10, hooks or similar facing towards the respective other electrode 8, 7, which on the one hand facilitate their positioning with respect to the individual battery cells 3 during assembly and on the other accordingly increase the surface of the electrodes 7, 8 which are in contact with the thermal foam 6. During assembly, these electrodes 7, 8 together with the individual battery cells 3 are positioned in the housing 2 before the remaining empty spaces are foamed with the thermal foam 6.

The thermal foam 6 now takes over the additional functionality of a module heater 60 by connecting the first electrode 8 to the positive pole 4 of the battery module 1 via the switching element 9, and by permanently connecting the other of the electrodes 7 to the negative pole 5 of the battery module 1. Thus, a current flows through the thermal foam 6 as a module heater 60, as is indicated by the arrows in FIG. 1 according to the technical current direction. The thermal foam 6 warms up and heats the individual battery cells 3 as a module heater 60.

As is indicated by the arrow marked with 11, the switching element 9, in particular when it is designed as an IGBT, can now be controlled accordingly via its gate voltage. This can preferably be used in order to realize a pulse-width-modulated control, in the case of which a measurement value of a temperature sensor 12, indicated in the representation of FIG. 2, is used as a control variable in order to adjust a desired target temperature of the battery module 1.

In the representation of FIG. 2, it can be seen that the housing 2 is sealed by a type of “cover” in the exemplary embodiment represented here. This is to be designed as a heat exchanger 13 known per se. It serves as a cover and cooling plate which is in heat-conducting connection with the individual battery cells 3 and cools the latter, when necessary, for example, by the heat exchanger 13 being flowed through by a coolant. This conventional type of cooling is now efficiently added to in the construction of the battery module 1 by using the thermal foam 6, which on the one hand serves to fix the individual battery cells 3 and on the other hand as a module heater 60, in order to be able to control the temperature of the battery module 1 in any desired way, for example to accordingly heat it via the module heater 60 or to accordingly cool it via the heat exchanger 13.

1.-10. (canceled)

11. A battery module (1), comprising:
a plurality of individual battery cells (3) in a housing (2); and
an integrated module heater (60), wherein the integrated module heater (60) is a foam material (6) which is disposed in an electric circuit together with a switching element (9);
wherein the foam material (6) is electrically conductive and fixes the plurality of individual battery cells (3) in the housing (2) and wherein when the switching element (9) is switched on an electric current flows through the foam material (6) and heats the foam material (6).

12. The battery module (1) according to claim 11, wherein the foam material (6) is a polyurethane foam with electrically conductive additives.

13. The battery module (1) according to claim 11, wherein the electric circuit connects poles (4, 5) of the battery module (1) via the switching element (9) and the integrated module heater (60).

14. The battery module (1) according to claim 11, wherein the switching element (9) is a bipolar transistor with an insulated gate electrode.

15. The battery module (1) according to claim 11, wherein the foam material (6) is connected to a first electrode (7) at a first end of the battery module (1) and a second electrode (8) at a second opposite end of the battery module (1).

16. The battery module (1) according to claim 15, wherein the first electrode (7) has a first projection or a first hook that protrudes in a direction of the second electrode (8) and the second electrode (8) has a second projection or a second hook that protrudes in a direction of the first electrode (7).

17. The battery module (1) according to claim 11, wherein the plurality of individual battery cells (3) are disposed in heat-conducting connection with a heat exchanger (13).

18. The battery module (1) according to claim 11, wherein the plurality of individual battery cells (3) are lithium-ion cells with liquid electrolyte.

19. A method for heating a battery having battery modules (1) according to claim 11, comprising the step of:
controlling the switching element (9) of a respective battery module (1) in a pulse-width-modulated manner according to a required heat energy.

20. The method according to claim 19, wherein heating of the respective battery module (1) is only activated when its state of charge is a specified threshold.
